(19) United States
(12) Patent Application Publication
(10) Pub. No.: US 2005/0116974 A1
(43) Pub. Date: Jun. 2, 2005

(54) Ink-jet recording apparatus

(75) Inventor: Katsuaki Suzuki, Gifu-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/996,379

(22) Filed: Nov. 26, 2004

(30) Foreign Application Priority Data
Nov. 27, 2003 (JP) 2003-396634

(51) Int. Cl. B41J 29/38

(52) U.S. Cl. 347/10

(57) ABSTRACT

An inkjet recording apparatus forms an image based on print data in which a gradation level is selected from a plurality of gradation levels with respect to each pixel. The ink-jet recording apparatus includes an ink-jet head including a plurality of nozzles that eject ink therefrom, a plurality of pressure chambers, each of which communicates with a corresponding one nozzle of the plurality of nozzles, and an actuator that allows the plurality of nozzles to eject ink thereform by applying pressure to ink stored in the plurality of the pressure chambers based on pulse train signals. The actuator is capable of allowing the plurality of nozzles to eject different amounts of ink based on the pulse train signals having different waveform patterns. The ink-jet recording apparatus further includes a waveform storage unit that stores a plurality of waveform patterns corresponding to the different amounts of ink to be ejected from the nozzles, a table storage unit that is provided with respect to each nozzle group including at least one of the plurality of nozzles and stores a correspondence table in which one of the plurality of waveform patterns stored in the waveform storage unit is independently selected and brought into correspondence with respect to each of the plurality of a gradation levels, and a signal generation unit that generates the pulse train signals having the respective waveform patterns, based on the correspondence table stored in each of the table storage units, so that ink is ejected from each of the nozzles with a volume in accordance with the waveform pattern assigned to each the gradation level.

### CROSS-REFERENCE TO RELATED APPLICATION

This application claims priority from JP 2003-396634, filed Nov. 27, 2003, the subject matter of which is incorporated herein in its entirety by reference thereto.

### BACKGROUND

1. Field

An ink-jet recording apparatus that performs printing by ejecting ink droplets onto a recording medium.

2. Description of Related Art

An ink-jet head used for an ink-jet printer distributes ink supplied from an ink tank to a plurality of pressure chambers therein and ejects ink droplets onto a recording medium from nozzles by selectively applying pulsed pressure to each pressure chamber. As a means for selectively applying the pressure to the pressure chambers, an actuator, in which a plurality of piezoelectric ceramic sheets are laminated one upon the other, may be used. In this case, in order to allow the nozzles to eject ink droplets with gradation levels of the ink droplets controlled, a predetermined signal is applied to electrodes provided to the actuator to drive the actuator. Japanese Laid-Open Patent Publication No. 2000-158643 discloses a technique of selecting a signal to be applied to the actuator from a plurality of signals after grasping ink ejecting conditions (history) on a nozzle basis, in order to optimize the ink ejection.

In the ink-jet head, a plurality of ink channels are provided so as to extend from the plurality of pressure chambers to the nozzles which communicate with the plurality of pressure chambers. The plurality of ink channels are formed by which thin metal plates, which have the ink channels patterned thereon by etching, are laminated one upon the other. In the ink-jet head, the nozzles and the pressure chambers are arranged very close to each other in high density in order to achieve a high-resolution image and a high-speed printing. In accordance with this, the ink channels provided in the ink-jet head have a further fine shape.

### SUMMARY OF THE INVENTION

However, the structure of the ink-jet head causes limitations in the formation of the ink channels, which results in physical imperfections, such as variations in the placement of the ink channels or the total length of the ink channels, or manufacturing errors in the ink channels. Then, the physical imperfections cause the ink ejection characteristics to vary among the nozzles. Japanese Laid-Open Patent Publication No. 2000-158643 does not disclose a technique of compensating for the variations in the ink ejection characteristics caused by the physical imperfections, so that the ink ejection characteristics cannot be made uniform among the nozzles. Therefore, the quality of the image formed by the above described ink-jet head may be deteriorated.

Disclosed is an ink-jet recording apparatus that can improve image quality even though ink ejection characteristics vary among nozzles. According to exemplary embodiment, an ink-jet recording apparatus forms an image based on print data in which a gradation level is selected from a plurality of gradation levels with respect to each pixel. The ink-jet recording apparatus includes an ink-jet head including a plurality of nozzles that eject ink therefrom, a plurality of pressure chambers, each of which communicates with a corresponding one of the plurality of nozzles, and an actuator that allows the plurality of nozzles to eject ink therefrom by applying pressure to ink stored in the plurality of the pressure chambers based on pulse train signals. The actuator is capable of allowing the plurality of nozzles to eject different amounts of ink based on the pulse train signals having different waveform patterns. The ink-jet recording apparatus further includes a waveform storage unit that stores a plurality of waveform patterns corresponding to the different amounts of ink to be ejected from the nozzles, a table storage unit that is provided with respect to each nozzle group including at least one of the plurality of nozzles and stores a correspondence table in which one of the plurality of waveform patterns stored in the waveform storage unit is independently selected and brought into correspondence with respect to each of the plurality of gradation levels, and a signal generation unit that generates the pulse train signals having the respective waveform patterns, based on the correspondence table stored in each of the table storage units, so that ink is ejected from each of the nozzles by a volume in accordance with the waveform pattern assigned to each gradation level.

The pulse train signals of the different waveform patterns can be applied to the plurality of nozzle groups even when the same gradation levels are set to the pixels. Therefore, the variations in the ink ejection characteristics among the nozzles caused by the variations in the shape of the ink-jet head or the manufacturing errors in the ink-jet head are compensated, thereby improving image quality.

An exemplary method of forming an image is based on print data in which a gradation level is selected from a plurality of gradation levels with respect to each pixel, using an ink-jet recording apparatus that comprises an ink-jet head including a plurality of nozzles that eject ink therefrom, a plurality of pressure chambers, each of which communicates with a one of the plurality of nozzles, and an actuator that allows the plurality of nozzles to eject ink therefrom by applying pressure to ink stored in the plurality of pressure chambers based on pulse train signals and is capable of allowing the plurality of nozzles to eject different amounts of ink based on the pulse train signals having different waveform patterns, includes the step of bringing different waveform patterns into correspondence with a plurality of gradation levels by nozzle group including at least one of the nozzles, the step of storing print data in which a gradation level is selected from the plurality of gradation levels with respect to each pixel, the step of determining a waveform pattern for ejecting ink from each of the nozzles by a volume corresponding to each gradation level, in accordance with the stored gradation levels and the correspondence, the step of generating a pulse train signal having the determined waveform pattern for ejecting ink from each of the nozzles, and the step of applying the generated pulse train signal to the actuator.

As a result, the pulse train signals of the different waveform patterns can be applied to the plurality of nozzle groups even when the same gradation levels are set to the pixels. Therefore, the variations in the ink ejection characteristics among the nozzles caused by the variations in the shape of the ink-jet head or the manufacturing errors in the ink-jet head are compensated, thereby improving image quality.

### BRIEF DESCRIPTION OF THE DRAWINGS

An exemplary embodiment will be described in detail with reference to the following figures wherein:

FIG. 1 is a general view of an ink-jet printer according to a first exemplary embodiment;

FIG. 2 is a perspective view of one of the ink-jet heads provided in the ink-jet printer of FIG. 1;

FIG. 3 is a sectional view of the ink-jet head, taken along a line III-III of FIG. 2;

FIG. 4 is a plan view of head bodies included in the ink-jet heads;

FIG. 5 is an enlarged view of the area enclosed with a dot and dash line in FIG. 4;

FIG. 6 is an enlarged view of the area enclosed with a dot and dash line in FIG. 5;

FIG. 7 is a functional block diagram of the ink-jet printer;

FIG. 8 is a diagram showing an example of waveform patterns to be used in the ink-jet printer;

FIG. 9 is a functional block diagram of a cyan head control portion;

FIG. 10 is a diagram showing an example of a correspondence table to be used in the ink-jet printer;

FIG. 11 is a flowchart of an operation procedure of a controller of the ink-jet printer;

FIG. 12A is a variation of the correspondence table to be used in the ink-jet printer; and

FIG. 12B is a variation of the correspondence table to be used in the ink-jet printer.

### DETAILED DESCRIPTION OF PREFERRED EMBODIMENTS

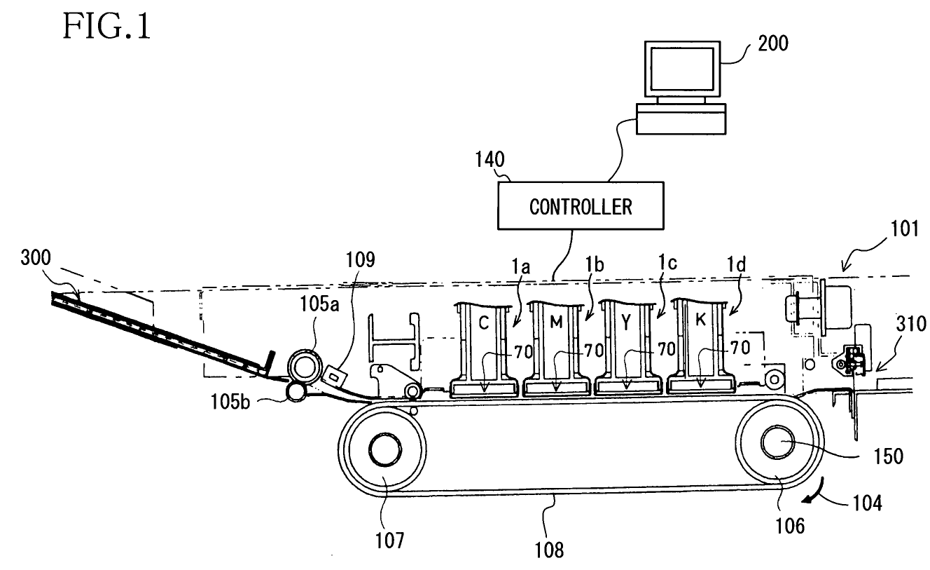

An ink-jet printer 101 of FIG. 1 is a color ink-jet printer having four ink-jet heads 1a, 1b, 1c, 1d. As shown in FIG. 1, the ink-jet printer 101 includes a sheet feed portion 300 on the left side of the drawing and a sheet discharge portion 310 on the right side of the drawing. The ink-jet printer 101 further includes a controller 140 that controls the ink-jet printer 101. A personal computer (PC) 200 is connected with the controller 140 of the ink-jet printer 101. A user can control the ink-jet printer 101 via driver software running on the PC 200.

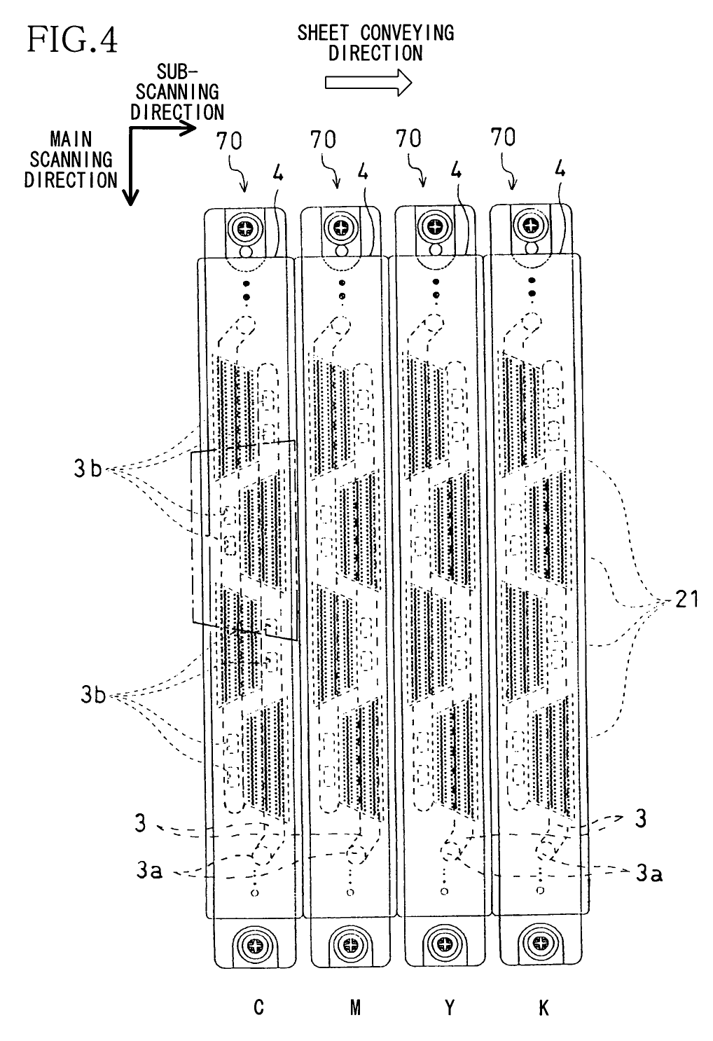

In the ink-jet printer 101, a sheet conveying path is provided so that a sheet (a recording medium) is conveyed from the sheet feed portion 300 to the sheet discharge portion 310. A direction extending from the sheet feed portion 300 to the sheet discharge portion 310 (a direction indicated by an arrow in FIG. 4) refers to a sheet conveying direction. An upstream and a downstream, in the sheet conveying direction, may hereinafter simply referred to as upstream and downstream, respectively. A pair of feed rollers 105a, 105b and a sheet sensor 109 are provided immediately downstream from the sheet feed portion 300 in the sheet conveying direction. The pair of feed rollers 105a, 105b pinch and convey the sheets one by one. The sheet is conveyed, by the pair of feed rollers 105a, 105b, from the left side to the right side, i.e., to substantially a middle area in the sheet conveying path, of FIG. 1. During the conveyance, the sheet sensor 109 recognizes the type of sheet, and outputs the recognition result to the controller 140. In the middle of the sheet conveying path, two belt rollers 106, 107, an endless conveyor belt 108, which runs between the belt rollers 106, 107, and a conveyor motor 150, which drives the belt rollers 106, 107, are provided. An outer surface, that is, the conveyor surface of the conveyor belt 108 is coated with silicone. Therefore, the conveyor belt 108 can convey the sheet fed by the feed rollers 105a, 105b, toward the downstream (the right side) in the sheet conveying direction, by rotation of the belt roller 106 in a clockwise direction (in a direction indicated by an arrow 104), while holding the sheet on the conveyor surface by its adhesive force.

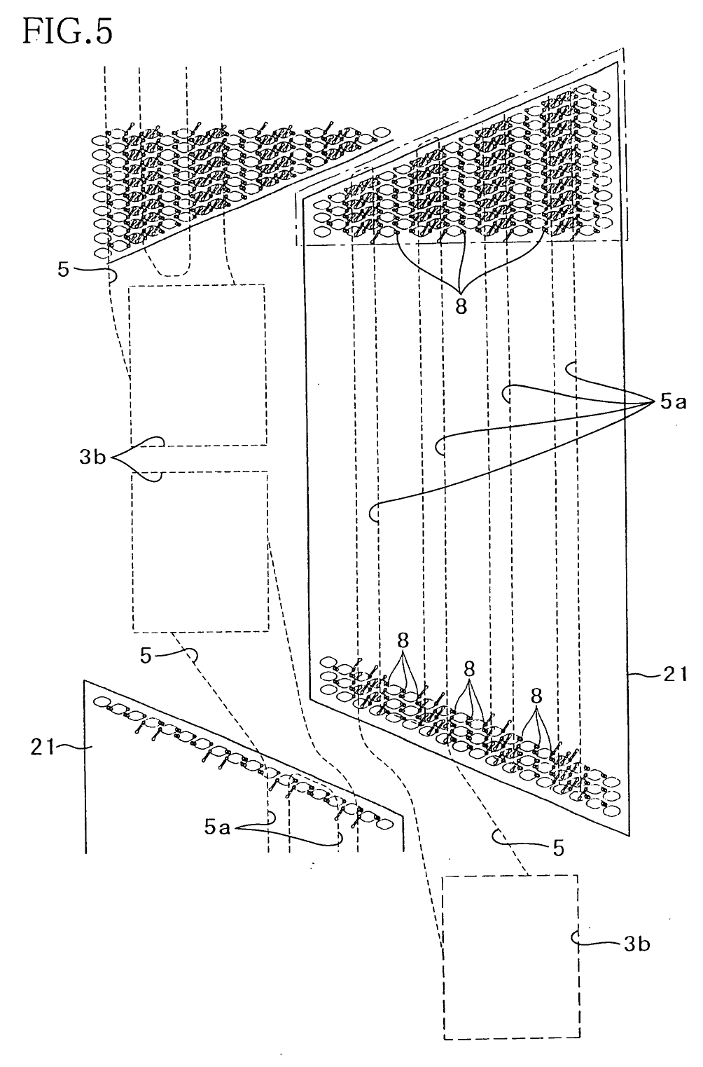

Each of the ink-jet heads 1a, 1b, 1c, 1d includes a head body 70 at its bottom. The head body 70 has a substantially rectangular shape in cross section. The ink-jet heads 1a, 1b, 1c, 1d are aligned adjacent to each other so that longer sides of their head bodies 70 extend in a direction perpendicular to the sheet conveying direction (in a direction perpendicular to the surface of the drawing sheet of FIG. 1). That is, the ink-jet printer 101 is a line printer. The bottom surfaces of the head bodies 70 of the ink-jet heads 1a, 1b, 1c, 1d are opposed to the sheet conveying path and are provided with nozzle plates including a plurality of nozzles 8 (FIG. 5) having an extremely small diameter. The ink-jet heads 1a, 1b, 1c, 1d eject cyan (C) ink, magenta (M) ink, yellow (Y) ink, and black (K) ink, respectively, from their head bodies 70.

The head bodies 70 of the ink-jet heads 1a, 1b, 1c, 1d are disposed such that a narrow clearance is created between their bottom surfaces and the conveyor surface of the conveyor belt 108. The clearance provides the sheet conveying path therebetween. With this structure, ink droplets of each color are ejected from the nozzles 8 onto an upper surface, i.e., a recording surface of the sheet while the sheet, which is being conveyed by the conveyor belt 108, passes under the head bodies 70 of the ink-jet heads 1a to 1d, thereby forming a desired color image on the sheet.

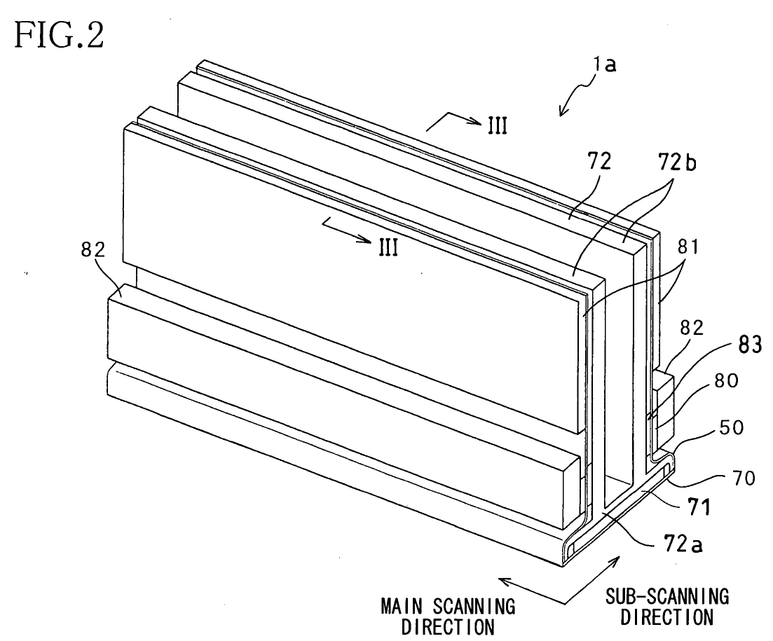

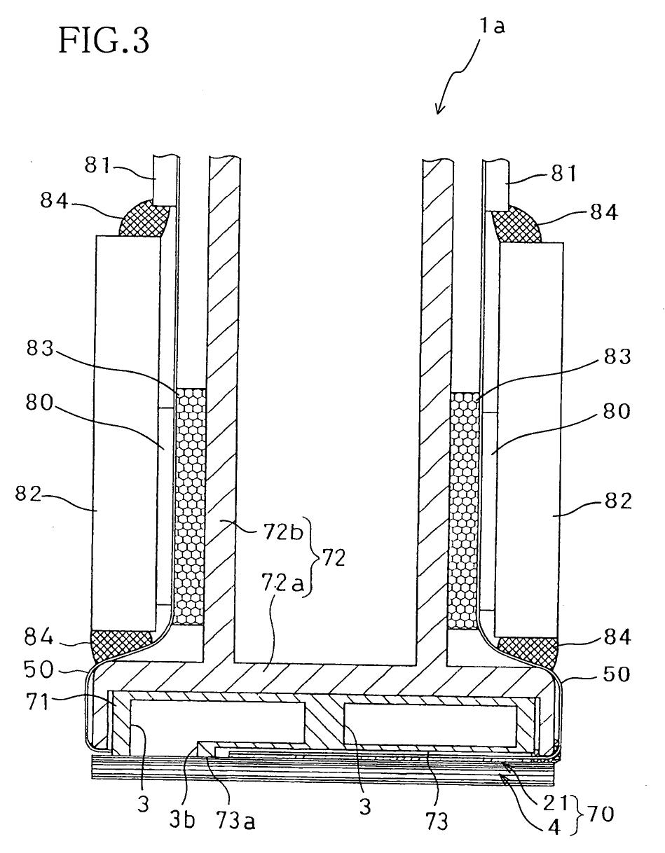

Next, the ink-jet heads 1a, 1b, 1c, 1d will be described in detail with reference to FIGS. 2 and 3. All the ink-jet heads 1a, 1b, 1c, 1d have substantially the same structure and function in substantially the same manner, although ejecting ink droplets of the different colors from their respective nozzles 8. Accordingly, an explanation will be given of ink-jet head 1a only. The ink-jet head 1a includes the head body 70 having a rectangular shape in a plan view and a base block 71. The head body 70 extends in a main scanning direction (FIG. 2) and ejects ink droplets onto sheets P. The base block 71 is disposed above the head body 70 and is provided with two ink storages 3 which are part of ink channels in which ink flows to be supplied to the head body 70.

The head body 70 further includes a channel unit 4 in which the ink channels are provided, and a plurality of actuator units 21 (FIG. 4). The actuator units 21 are adhered to an upper surface of the channel unit 4. The channel unit 4 and the actuator units 21 are formed by which a plurality of thin plates are laminated one upon the other. A flexible printed circuit (FPC) 50, as a power supply member, is adhered to a top of each actuator unit 21 and is drawn to the right or left side of the ink-jet head 1a, in FIG. 3. The base block 71 is made of metal material, for example, stainless steel. The ink storages 3 provided in the base block 71 are defined by hollow areas having substantially a rectangular parallelepiped extending in a direction along a longitudinal direction of the base block 71.

The base block 71 includes a bottom surface 73 and openings 3b. In the bottom surface 73, the vicinity of each opening 3b protrudes downward from the surrounding portion. The reference numeral 73a designates the vicinity portion. The base block 71 is in contact with the channel unit 4 at the vicinity portion 73a of each opening 3b of the bottom surface 73. Therefore, the area of the bottom surface 73 of the base block 71, other than the vicinity portion 73a of each opening 3b, is separated from the head body 70. The actuator units 21 are provided in the space created between the head body 70 and the base block 71.

The ink-jet head 1a includes a holder 72. The holder 72 includes a holding portion 72a whose bottom has a recessed portion. The base block 71 is fixedly adhered to the holder 72 in the recessed portion of the holding portion 72a. The holder 72 further includes a pair of projecting portions 72b having a flat plate shape. The pair of projecting portions 72b extend upward from an upper surface of the holding portion 72a in a direction perpendicular to a direction that the upper surface of the holding portion 72a extends, at a predetermined distance from each other. The flexible printed circuits 50 adhered to the respective actuator units 21 are disposed such that the elongated portions drawn to the right or left side extend along the respective surfaces of the projecting portions 72b of the holder 72 with elastic members 83 being provided between the projecting portions and the elongated portions of the flexible printed circuits 50. A driver IC 80 is provided on each flexible printed circuit 50 in order to drive the actuator units 21. The flexible printed circuits 50 are electrically connected by soldering with the respective driver ICs 80 and the respective actuator units 21 so that drive signals outputted by the driver ICs 80 are transmitted to the actuator units 21 of the head body 70.

Heat sinks 82 having substantially a rectangular parallelepiped shape are intimately provided on the outer surface of the driver ICs 80 in order to efficiently dissipate heat generated by the driver ICs 80. Substrates 81 are provided above the driver ICs 80 and the heat sinks 82 and on the outer surfaces of the flexible printed circuits 50. Clearance between the upper surfaces of the heat sinks 82 and the lower surfaces of the substrates 81 and between the lower surfaces of the heat sinks 82 and the flexible printed circuits 50 are adhered respectively by seal members 84.

FIG. 4 is a plan view of the head body 70 of FIG. 2. In FIG. 4, the ink storages 3 provided in the base block 71 are indicated by a dashed line. The two ink storages 3 extend along the longitudinal direction of the head body 70, in parallel to and at a predetermined distance from each other. Each of the ink storages 3 of each head body 70 includes an opening 3a, at one end, that communicates with an ink tank (not shown). Thus, the ink storages 3 are filled with ink all the time. The ink storages 3 each include the plurality of openings 3b provided along the longitudinal direction of the head body 70. As described above, the plurality of openings 3b connect each ink storage 3 to the channel unit 4. The plurality of openings 3b are paired such that the paired openings 3b are disposed close to each other along the longitudinal direction of the head body 70. The pairs of openings 3b communicating with one of the ink storages 3 and the pairs of openings 3b communicating with the other ink storage 3 are provided in two lines in a staggered arrangement.

In areas where the openings 3b are not provided, the plurality of trapezoidal actuator units 21 are provided in two lines in a staggered arrangement in the arrangement reverse to the arrangement of the openings 3b. Each actuator unit 21 is disposed such that its opposing parallel sides (upper and lower sides) extend in a direction parallel to the longitudinal direction of the head body 70. Oblique sides of each neighboring actuator units 21 partially overlap each other in the width (lateral) direction of the head body 70.

FIG. 5 shows an enlarged view of the area enclosed with a dot and dashed line in FIG. 4. As shown in FIG. 5, the openings 3b provided to the ink storages 3 communicate with respective manifolds 5, which are common ink chambers. An end of each manifold 5 branches into two sub-manifolds 5a. When viewed from above, the two sub-manifolds 5a extend from each of the adjacent openings 3b toward the oblique sides of the actuator units 21. That is, a total of four sub-manifolds 5a extend under each actuator unit 21 so as to extend along the opposing parallel sides of the actuator unit 21, at a predetermined distance from each other.

A lower surface of the channel unit 4, corresponding to the adhered area of each actuator unit 21, includes an ink ejecting area. In the surface of each ink ejecting area, a plurality of nozzles 8 are arranged in a matrix, as described later. Although FIG. 5 does not show all of the plurality of nozzles 8 in order to simplify the drawing, the nozzles 8 are provided to the entire ink ejecting area of each actuator 21.

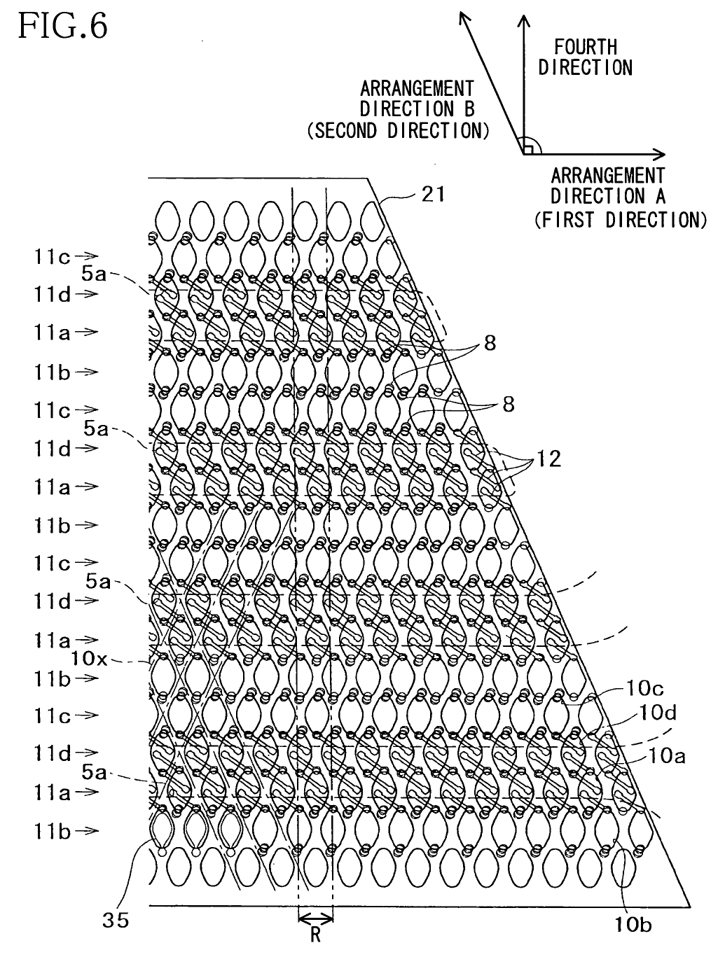

FIG. 6 shows an enlarged view of the area enclosed by a dot and dash line in FIG. 5, wherein a plane in which a plurality of pressure chambers 10 are arranged in a matrix in the channel unit 4 is shown when viewed from a direction perpendicular to the ink ejecting surface. Each pressure chamber 10 has substantially a rhombic planer shape and rounded corners when viewed from above. When diagonal lines are provided in each rhombic-shaped pressure chamber 10, each pressure chamber 10 is arranged such that its longer diagonal line extends in parallel to the width direction of the channel unit 4. In each pressure chamber 10, its one end communicates with the nozzle 8 and its other end communicates with the sub-manifold 5a as the common ink channel, via an aperture 12 (FIG. 6). Individual electrodes 35 are provided on the actuator units 21 at positions corresponding to the pressure chambers 10, when viewed from above. Each individual electrode 35 has a shape similar to the pressure chamber 10 when viewed from above and is slightly smaller in size than the pressure chamber 10. FIG. 6 does not show all of the individual electrodes 35 in order to simplify the drawing. It should be noted that, in FIGS. 5 and 6, the pressure chambers 10 and the apertures 12 are indicated by a solid line for the purpose of clarity although they should be indicated by a dashed line because they are provided inside of the actuator units 21 or the channel unit 4.

As shown in FIG. 6, a plurality of rhombic areas 10x, which are imaginary areas indicated by a dot and dashed line, are arranged adjacent to each other in a matrix in two directions, an arrangement direction A (a first direction) and an arrangement direction B (a second direction) as indicated by arrows in FIG. 6, so that the plurality of rhombic areas 10x do not overlap each other. The rhombic areas 10×house the respective pressure chambers 10 therein. The arrangement direction A is coincident with the longitudinal direction of the ink-jet head 1a, that is, the extending direction of the sub-manifolds 5a, and extends in a direction parallel to a shorter diagonal line of each rhombic area 10x. The arrangement direction B is coincident with the direction along one oblique side of the rhombic area 10x and forms an obtuse angle θ with the arrangement direction A. Each pressure chamber 10 and each corresponding rhombic area 10x have a common center. The contours of the pressure chambers 10 and the corresponding rhombic areas 10x are separated from each other when viewed from above.

The pressure chambers 10 are arranged in a matrix adjacent to each other in the arrangement directions A and B and at a distance R corresponding to 37.5 dpi from each other in the arrangement direction A. There are eighteen pressure chambers 10 at the maximum in the arrangement direction B in each ink ejection area. The pressure chambers 10 provided along each edge or outer line relative to the arrangement direction B (i.e., top and bottom lines shown in FIG. 6), of each ink ejection area, are pseudo pressure chambers, which do not contribute to the ink ejection.

The plurality of pressure chambers 10 arranged in a matrix provide a plurality of rows of the pressure chambers 10 in the arrangement direction A as shown in FIG. 6. The rows of the pressure chambers 10 include first pressure chamber rows 11a, second pressure chamber rows 11b, third pressure chamber rows 11c, and fourth pressure chamber rows 11d, in accordance with relative position relationship with the sub-manifolds 5a, when viewed from a direction perpendicular to the drawing sheet of FIG. 6 (a third direction). The first to fourth pressure chamber rows 11a to 11d are alternately arranged in order that the third pressure chamber row 11c, the fourth pressure chamber row 11d, the first pressure chamber row 11a, and the second pressure chamber row 11b, from the upper side to the lower side in each of the actuator units 21. Four each sets of the first to fourth pressure chamber rows 11a to 11d are arranged in each of the actuator units 21.

The first pressure chamber rows 11a include pressure chambers 10a and the second pressure chamber rows 11b include pressure chambers 10b. In the pressure chambers 10a, 10b, the nozzles 8 are disposed at one side, i.e., the lower side, of the drawing sheet of FIG. 6, with respect to the fourth direction perpendicular to the arrangement direction A when viewed from the third direction (into the drawing). The nozzles 8 are located at lower tip portions of the corresponding rhombic areas 10x. The third pressure chamber rows 11c include pressure chambers 10c and the fourth pressure chamber rows include pressure chambers 10d. In the pressure chambers 10c, 10d, the nozzles 8 are disposed at one side, i.e., the upper side, of the drawing sheet of FIG. 6, with respect to the fourth direction when viewed from the third direction. The nozzles 8 are located at upper tip portions of the corresponding rhombic areas 10x. In the first and fourth pressure chamber rows 11a, 11d, more than half of the areas of the pressure chambers 10a, 10d overlap the sub-manifolds 5a. In the second and third pressure chamber rows 11b, 11c, no portion of the pressure chambers 10b, 10c overlaps the sub-manifolds 5a. Therefore, ink can be smoothly supplied to each pressure chamber 10 (10a to 10d) while the widths of the sub-manifolds 5a are extended as much as possible and the nozzles 8 which communicate with the pressure chambers 10 belonging to any pressure chamber row 11a to 11d do not overlap the sub-manifolds 5a.

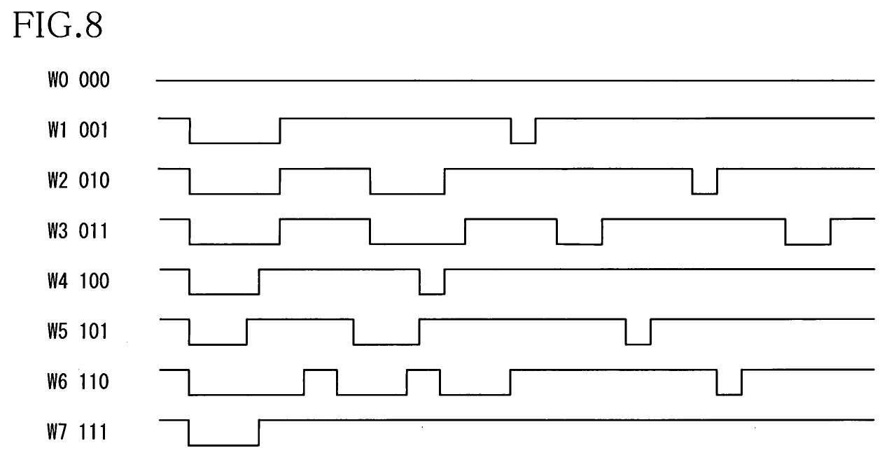

In the actuator units 21, the individual electrodes 35 are placed at a predetermined potential (a first potential) in advance. Every time an ink ejection is requested, the individual electrodes 35 are placed at a second potential which is different from the first potential and then are returned to the first potential at a predetermined timing. At the time the individual electrodes 35 are at the second potential, the volume of the pressure chambers 10 increases and ink pressure in the pressure chambers 10 is reduced, so that the ink is taken in by the pressure chambers 10 from the sub-manifolds 5a. Then, at the time the individual electrodes 35 are at the first potential, the volume of the pressure chambers 10 decreases to the original volume, the ink pressure in the pressure chamber 10 is increased and the ink is ejected from the nozzles. That is, a rectangular wave pulse is applied to each individual electrode 35. A width of the pulse is generally an acoustic length AL that is a propagation time length of the pressure waves from the sub-manifolds 5a to the nozzles 8 in the pressure chambers 10. When the internal pressure of the pressure chambers 10 is changed to a positive pressure from a negative pressure, both the positive pressures generated by the volume decrease of the pressure chamber 10 and generated by the change of the internal pressure are combined in the pressure chambers 10, so that the ink can be ejected from the nozzles 8 by strong pressure. A predetermined potential difference should be provided between the first potential and the second potential in order to eject ink from the nozzles 8. In the exemplary embodiment, the first potential is 20 V, and the second potential for ink ejection is −5 V (FIG. 8). However, the potential values are not limited to the exemplary embodiment. Different potential values may be adopted in accordance with the structure and/or a control manner of the actuator units 21.

By the operation of the actuator units 21, driven in accordance with pulse waves (waveform patterns) outputted from the driver ICs 80, ink droplets are ejected in amounts corresponding to the respective gradation levels, from the nozzles 8 of the ink-jet head 1a having the described structure. At that time, each gradation level is expressed by a volume of ink to be adjusted by the number of ink droplets to be ejected from the nozzle 8, so that ink droplets are successively ejected from the nozzle 8. In a case where the ink droplets are successively ejected, generally, an interval between pulses, which are to be provided in order to eject the ink droplets, is set to AL. A peak of a residual pressure wave of a previous pressure applied for ink ejection and a peak of a pressure wave of a subsequent pressure applied for ink ejection are coincident with each other in the periods thereof. Accordingly, the previous pressure and the subsequent pressure are superimposed and thus amplified. Therefore, the ejection speed of the ink droplet subsequently ejected is faster than the ejection speed of the ink droplet previously ejected. Thus, the subsequent ink droplet catches up with and comes into collision with the previous ink droplet in the air, and the two ink droplets coalesce into one ink droplet.

In the manner described above, ink droplets are ejected from each nozzle 8 by the amount corresponding to each gradation level. However, the ink ejection characteristics may be different among the nozzles 8. Thus, even when ink droplets are ejected from the nozzles 8 by using a waveform pattern for the same gradation level, the amount of ink ejected from the nozzles 8 may be different from each other. The variations in the ink ejection characteristics among the nozzles 8 are traceable to manufacturing errors in the nozzle diameters. In addition, like the exemplary embodiment, when the nozzles 8 are densely arranged in a matrix and the structure of the ink channels and the provided locations of the actuator units 21 are different among the pressure chamber rows 11a to 11d, the ink ejection characteristics of the nozzles 8 may be different from each other among the pressure chamber rows 11a to 11d. The ink ejection characteristics are also affected by temperature and humidity. Therefore, if at least one of the temperature and the humidity is changed in the printing environment, the same image quality cannot be obtained at all times even when the image is formed by using the same print data. Further, the appropriate amount of ink to be ejected in order to obtain the same gradation level may be different according to recording media on which an image is printed. In the ink-jet printer 101 of the exemplary embodiment, the waveform pattern to be inputted into each individual electrode 35 corresponding to each nozzle 8 can be assigned in accordance with the ink ejection characteristics of each nozzle 8 in order to compensate for the variations in the ink ejection characteristics among the nozzles 8 and to maintain excellent image quality.

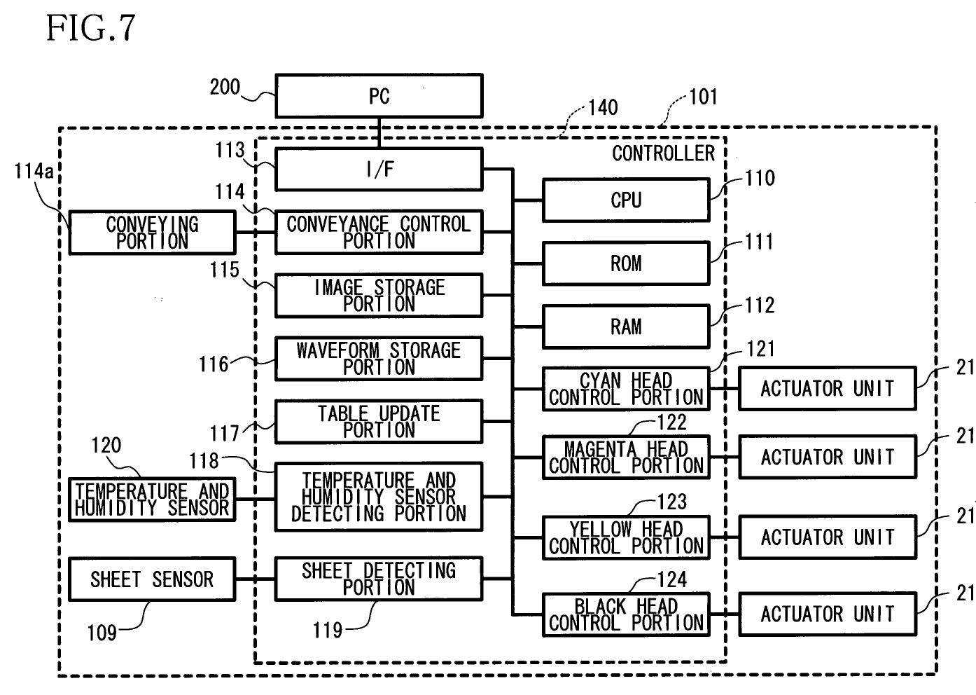

Next, the controller 140 will be described in detail with reference to FIG. 7. The controller 140 includes a CPU 110 as an operating device, a ROM 111 that stores programs to be executed by the CPU 110 and data to be used by the programs, a RAM 112 that temporarily stores data during execution of the programs. The CPU 110, the ROM 111, and the RAM 112 function to control other functional portions described below. More specifically, the CPU 110 issues a function command to the functional portions. Then, each functional portion writes its status into a predetermined registry of the RAM 112. The CPU 110 refers to the contents of the registry to grasp the status of each functional portion.

The controller 140 includes, as the functional portions, an interface (I/F) 113, a conveyance control portion 114, an image storage portion 115, a waveform storage portion 116, a table update portion 117, a temperature and humidity sensor detecting portion 118, a sheet detecting portion 119, a cyan head control portion 121, a magenta head control portion 122, a yellow head control portion 123, and a black head control portion 124. These functional portions are hardware components achieved by ASICs (Application Specific Integrated Circuits). A single ASIC may include a single functional portion, some of the functional portions, or all of the functional portions. The CPU 110 controls the functional portions by checking the status of each functional portion in accordance with the program stored in the ROM 111 and by issuing a command with respect to each functional portion.

The interface 113 is provided to allow the PC 200 operated by the user to connect the ink-jet printer 101. The conveyance control portion 114 controls the conveyor motor 150 that drives the belt rollers 106, 107, and a conveying portion 114a including a motor that drives the feed rollers 105a, 105b. The image storage portion 115 stores print data to be printed as image data. The print data is transmitted to the ink-jet printer 101 from the PC 200 via the interface 113 by which the user performs an operation for print execution.

The waveform storage portion 116 stores rewritable waveform patterns W0 to W7 which are signals to be applied to the individual electrodes 35 of the actuator units 21. FIG. 8 shows an example of the waveform patterns W0 to W7. In order to distinguish the waveform patterns W0 to W7 from each other, each waveform pattern W0 to W7 is assigned an identification code represented by three bits (000 to 111). As shown in FIG. 8, there are eight waveform patterns W0 to W7 stored in the waveform storage portion 116. The waveform pattern W0 is a pattern for not ejecting any ink droplets from a nozzle 8. The waveform patterns W1, W4 are patterns for ejecting a small ink droplet (formed by one drop) from a nozzle 8. The waveform patterns W2, W5 are patterns for ejecting a middle ink droplet (formed by two drops) from a nozzle 8. The waveform patterns W3, W6 are patterns for ejecting a large ink droplet (formed by three drops) from a nozzle 8. The waveform pattern W7 is a pattern for allowing a nozzle 8 to perform flushing (one drop). The waveform patterns W0 to W7 are empirically determined by changing the pulse width and the pulse interval of a reference pulse pattern whose pulse width and interval is AL so that the amount of ink to be ejected becomes a desired value.

Although both the waveform patterns W1, W4 are the patterns for ejecting a small ink droplet, an amount of ink to be ejected by the waveform pattern W4 is slightly larger that that to be ejected by the waveform pattern W1. Likewise, amounts of ink to be ejected by the waveform patterns W5, W6 are slightly larger than those to be ejected by the waveform patterns W2, W3, respectively. The flushing is a preliminary ink ejecting operation performed before a printing operation is performed, in order to remove ink clogging the nozzles 8, and is performed on all the nozzles 8 regardless of whether the nozzles 8 eject ink during the printing. By changing the width of the pulses, the successive pulse application timing, and the width and application timing of a cancel pulse, which is added to a tail of the pulse trains to compensate for excess pressure in the pressure chambers 10, the ink ejection characteristics of the nozzles 8 can be changed.

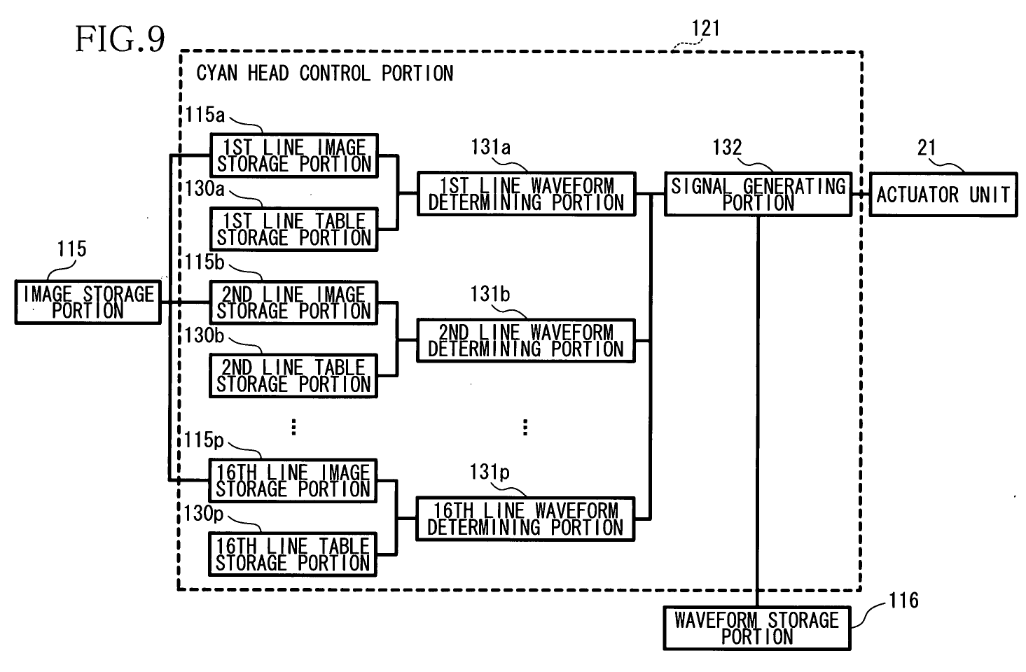

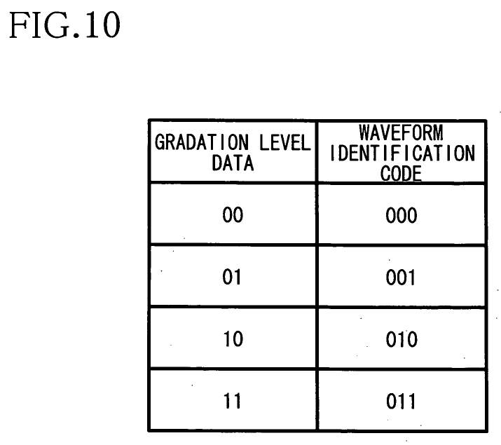

The table update portion 117 rewrites or changes the contents of correspondence tables stored in respective first to sixteenth line table storage portions 130a to 130p (FIG. 9) of each head control portion 121 to 124. FIG. 10 shows an example of the correspondence tables. Each of the correspondence tables includes gradation level data represented by two bits (00 to 11) used to express an image in print data and the identification codes represented by three bits (000 to 111) corresponding to the waveform patterns W0 to W7, wherein the gradation level data and the identification codes are brought into correspondence with each other. The table update portion 117 can update or rewrite the contents of the correspondence tables in accordance with an operation performed by the user, a detection result by the temperature and humidity sensor detecting portion 118, or a detection result by the sheet sensor 109, so that an optimal ink ejection result can be obtained.

In the ink ejection characteristics of the nozzles 8, when the ambient temperature is low, the viscosity of the ink increases, so that the amount of ink to be ejected from the nozzles 8 is slightly smaller than the normal condition. Therefore, it is preferable that the amount of ink to be ejected be slightly increased when the ambient temperature is at a predetermined temperature or below in order to form an image having the consistent gradation level under any conditions. In this exemplary embodiment, the waveform pattern to be used for ink ejection is changed at the predetermined temperature or below to increase the amount of ink to be ejected. For example, the waveform patterns W1, W2, W3 are used to eject small, middle, and large ink droplets, respectively, at ordinary temperatures. When the ambient temperature is the predetermined temperature or below at the time of printing, the contents of the correspondence tables are changed from the waveform patterns W1, W2, W3 to the waveform patterns W4, W5, W6, respectively, in order to slightly increase the amount of ink to be ejected. Therefore, an image having a gradation level which is the same as that at the ordinary temperatures can be obtained.

When humidity is low, the viscosity of the ink increases due to evaporation, so that the amount of ink to be ejected from the nozzles 8 is slightly smaller than the normal condition even when the same waveform pattern is used. Therefore, in a manner similar to the low temperature condition, when the humidity is a predetermined humidity or lower, the contents of the correspondence tables are changed in order to slightly increase the amount of ink to be ejected compared with the ink ejection amount for the same gradation level when the humidity is higher than the predetermined humidity. Thus, a constant image quality (the same gradation level) can be maintained. In addition, an ink absorption coefficient is different between a normal printing sheet and a printing sheet for photos. Therefore, an appropriate amount of ink to be ejected for representing each gradation level is different between types of sheets to be used. When an image is formed on a normal printing sheet, it is preferable to select a waveform pattern for ejecting ink whose amount to be ejected is less than that for the printing sheet for photos because a blur is likely to occur in the normal printing sheet. In the exemplary embodiment, by changing the contents of the correspondence tables, it can be set that the amount of ink to be ejected for the normal printing sheet is less than other types of sheets with respect to the same gradation level.

Moreover, ink ejection characteristics may vary among nozzle groups communicating with the respective sixteen pressure chamber rows 11a to 11d arranged in each actuator unit 21 because of manufacturing errors and variations in the shape of the ink-jet heads 11a to 11d. That is, the amount of ink to be ejected from the nozzles 8 may vary among the nozzle groups even when the same waveform pattern is applied to the individual electrodes 35 corresponding to respective nozzle groups. In this exemplary embodiment, a user can set the waveform patterns for ejecting a small, middle and large ink droplet as W1, W2 and W3 respectively in the correspondence tables for some of the nozzle groups and set the waveform patterns for ejecting a small, middle and large ink droplet as W4, W5 and W6 respectively in the correspondence tables for the other nozzle groups. Thus, it can be set that the amount of ink to be ejected from the nozzles 8 is the same among the nozzle groups with respect to the same gradation level.

The temperature and humidity sensor detecting portion 118 is connected to the temperature and humidity sensor 120 to detect the temperature and humidity surrounding the head bodies 70. The temperature and humidity sensor 120 is provided in one of the driver ICs 80. The sheet detecting portion 119 detects the type of printing sheets used (for example, normal printing sheets, printing sheets for ink-jet printers, and printing sheets for photos). The cyan head control portion 121, the magenta head control portion 122, the yellow head control portion 123, and the black head control portion 124 include the driver IC 80 and control the respective head bodies 70 of the ink-jet heads 1a, 1b, 1c, 1d.

The head control portions 121 to 124 will be described below in detail with reference to FIG. 9. All of the head control portions 121 to 124 have substantially the same structure. Thus, an explanation will be given for the cyan head control portion 121 only. As shown in FIG. 9, the cyan head control portion 121 includes first to sixteenth line image storage portions 115a to 115p, first to sixteenth line table storage portions 130a to 130p, first to sixteenth waveform determining portions 131a to 131p, each of which corresponds to one of nozzle groups communicating with the respective sixteen pressure chamber rows 11a to 11d arranged in each actuator unit 21 from the upper side to the lower side, and a signal generating portion 132. The first to sixteenth line image storage portions 115a to 115p store the gradation level data of ink to be ejected from each nozzle 8 in the respective nozzle groups of the corresponding lines and are connected to the image storage portion 115. For an image of the print data stored in the image storage portion 115, print data of an area corresponding to each of the pressure chamber rows 11a to 11d is transmitted, as gradation level data, to each of the first to sixteenth line image storage portions 115a to 115p. Then, each image storage portion 115a to 115p stores the received gradation level data of the print data therein. The stored gradation level data refers to the four kinds of data represented by two bits (00 to 11) described above. The print data may be transmitted to the controller 140 after the print data is developed into gradation level data represented by two bits at the PC 200 side. Alternatively, the print data may be transmitted to the controller 140 from the PC 200 as a non-bit image without being developed into gradation level data and may be developed into gradation level data represented by two bits at the controller 140 side.

Each table storage portion 130a to 130p stores the correspondence table in which the gradation level data represented by two bits stored in each image storage portion 115a to 115p and the identification codes represented by three bits for the waveform patterns W0 to W7 stored in the waveform storage portion 116 are brought into correspondence with each other. The correspondence table is independently provided for each nozzle group communicating with the corresponding pressure chamber row 11a to 11d of each head body 70. In the correspondence tables, waveform patterns for ejecting small, medium, and large ink droplets are selected from the waveform patterns W1 to W6 and assigned so as to eliminate the variations in the ink ejection characteristics of the nozzles 8. An example of the correspondence table is shown in FIG. 10. In the correspondence table of FIG. 10, for the gradation level data (01) for ejecting a small ink droplet, the waveform pattern W1 (001), selected from the waveform patterns W1, W4, is assigned. For the gradation level data (10) for ejecting a middle ink droplet, the waveform pattern W2 (010), selected from the waveform patterns W2, W5, is assigned. For the gradation level data (11) for ejecting large ink droplet, the waveform pattern W3 (011), selected from the waveform patterns W3, W6, is assigned. The waveform pattern for each gradation level data is selected from two options as described above. For the gradation level data (00) for not ejecting ink droplets, the waveform pattern W0 (000) is assigned.

Each waveform determining portion 131a to 131p determines a waveform pattern of a signal to be applied to each individual electrode 35 of the actuator units 21 corresponding to the nozzle group of the head body 70, in accordance with the gradation level data of two bits stored in each line image storage portion 115a to 115p and the correspondence table stored in each table storage portion 130a to 130p. According to FIG. 10, for example, when the gradation level data is (00), the identification code of the waveform data is (000), so that the waveform pattern of the signal to be applied is assigned to the waveform pattern W0. When the gradation level data is (01), the identification code of the waveform data is (001), so that the waveform pattern of the signal to be applied is assigned to the waveform pattern W1. When the gradation level data is (10), the identification code of the waveform data is (010), so that the waveform pattern of the signal to be applied is assigned to the waveform pattern W2. When the gradation level data is (11), the identification code of the waveform data is (011), so that the waveform pattern of the signal to be applied is assigned to the waveform pattern W3.

The signal generating portion 132 reads the waveform patterns from the waveform pattern storage portion 116, based on the identification codes of the waveform patterns W0 to W7 determined by each waveform determining portion 131a to 131p, and generates signals to be applied to the individual electrodes 35 of the actuator units 21. The generated signals are directly applied to the individual electrodes 35.

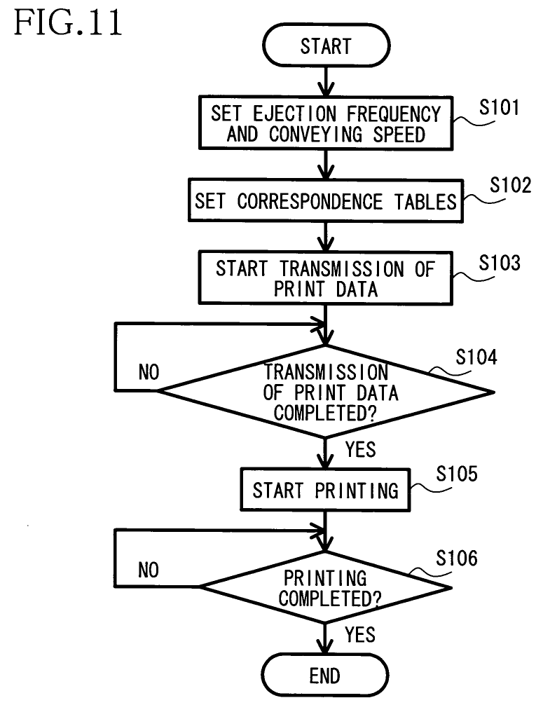

Next, an operation procedure of the controller 140 during printing will be described with reference to FIG. 11. Upon the issue of a print execution command from the PC 200, a printing operation is performed in the ink-jet printer 101 and the process of FIG. 11 is executed. At S101, an ejection frequency and a sheet conveying speed of the head bodies 70 are set based on the settings of a high-speed printing and high-quality printing set by the user. Then, at S102, the correspondence table is set with respect to each table storage portion 130a to 130p. At that time, when it is necessary to change the contents of the correspondence table which has been already set based on the user's settings, the detection results of the temperature and humidity sensor detecting portion 118 and the sheet detecting portion 119 are used to determine the optimal contents and the contents of the already-set correspondence table are changed or rewritten by the table update portion 117.

At S103, a command to start transmission of print data is issued. When the command is issued, the print data is transmitted to the image storage portion 115 via the interface 113 from the PC 200. The print data transmitted to the image storage portion 115 is further transmitted to each of the first to sixteenth line image storage portions 115a to 115p. Then, at S104, it is determined whether the transmission of the print data has been completed. When the transmission of the print data has not been completed yet (S104:NO), the determination of S104 is repeatedly performed until the transmission of the print data is completed. When the transmission of the print data has been completed (S104:YES), flow moves to S105 to issue a command to perform printing. Upon the issue of the command, the printing is performed while the head bodies 70 are driven in accordance with the ejection frequency set at S101 and the sheet is conveyed in accordance with the sheet conveying speed set at S101. After that, at S106, it is determined whether the printing has been completed. When the printing has not been completed (S106:NO), the determination of S106 is repeatedly performed until the printing is completed. When the printing has been completed (S106:YES), the process of FIG. 11 is finished.

According to the above exemplary embodiment, the pulse train signals having different waveform patterns can be applied to the individual electrodes 35 corresponding to the plurality of the nozzle groups in the actuator units 21 even when the gradation level in the print data is the same. Accordingly, the variations in the ink ejection characteristics of the nozzles 8 are compensated even when the ink ejection characteristics vary among the nozzle groups due to the variations in shape of the ink-jet heads 11a to 11d and the manufacturing errors. Thus, the image quality can be improved.

There is often a case where the ink ejection characteristics of the nozzles 8 communicating with the same row of the pressure chamber rows 11a to 11d are similar to each other. Therefore, by providing the correspondence table with respect to each pressure chamber row 11a to 11d, the image quality can be improved and the control of the gradation levels can be simplified.

In addition, the table storage portions 130a to 130p are provided for each of the ink-jet heads 1a to 1d, so that the variations in the ink ejection characteristics are compensated even when the ink ejection characteristics vary among the ink-jet heads 1a to 1d. Thus, the image quality can be improved.

The correspondence tables that include the contents suitable for the current temperature and humidity or the type of printing sheets to be used can be used by the provision of the table update portion 117, so that the image quality can be improved. The contents of the correspondence tables are automatically changed by the table update portion 117, so that the burden, on the user, of changing the contents can be reduced.

In a line head, generally, the number of nozzles provided in the head is larger than a serial head and the ink ejection characteristics of the nozzles are likely to vary. However, even though the ink-jet heads 1a to 1d of the line head are used, the image quality can be improved by controlling the gradation levels as described above.

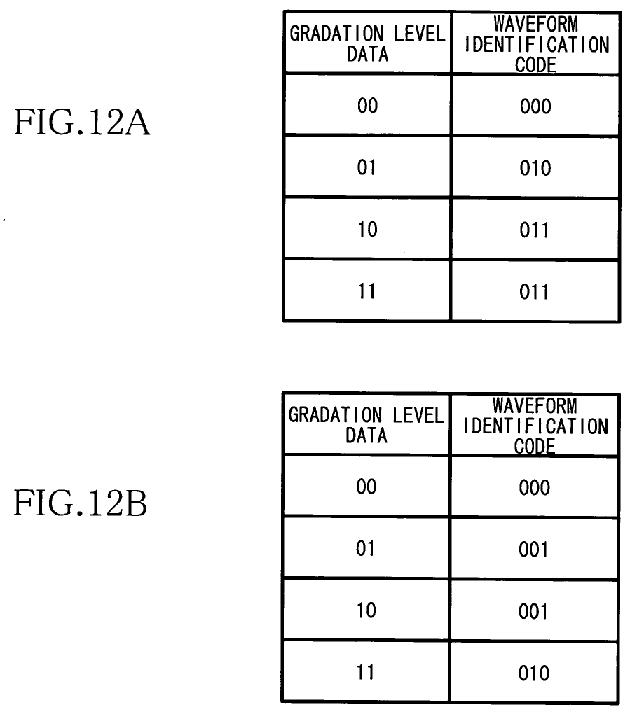

In the exemplary embodiment, one of the waveform patterns W1 (001) and W4 (100) is selected and assigned to the gradation level data (01) for ejecting a small ink droplet, one of the waveform patterns W2 (010) and W5 (101) is selected and assigned to the gradation level data (10) for ejecting a medium ink droplet, and one of the waveform patterns W3 (011) and W6 (110) is selected and assigned to the gradation level data (11) for ejecting a large ink droplet. However, it is not limited to the exemplary embodiment. The waveform patterns W1 to W6 can be freely assigned to the other gradation level data. For example, as shown in FIG. 12A, the gradation level data (01) for a small ink droplet can be assigned the waveform pattern W2 (010) for a middle ink droplet and the gradation level data (10) for a, middle ink droplet can be assigned the waveform pattern W3 (011) for a large ink droplet. Thus, the gradation level of the entire image can be increased. On the other hand, as shown in FIG. 12B, the gradation level data (10) for a middle ink droplet can be assigned the waveform pattern W1 (001) for a small ink droplet and the gradation level data (11) for a large ink droplet can be assigned one of the waveform patterns W2 (010) and W5 (101). Thus, the gradation level of the entire image can be reduced. By doing so, even if the ink ejection characteristics of the nozzles 8 significantly vary due to the temperature and humidity, the image quality can be constantly maintained. In addition, the amount of ink to be ejected can be changed according to the types of the printing sheets to be used.

While the invention has been described in detail with reference to the specific embodiment thereof, it would be apparent to those skilled in the art that various changes, arrangements and modifications may be applied therein without departing from the spirit and scope of the invention. For example, in the exemplary embodiment, the nozzles 8 are arranged in matrix in the head bodies 70. However, the nozzles 8 may be arranged in a random pattern, in a wave pattern, or in a line.

In the exemplary embodiment, each nozzle group includes the nozzles 8 arranged in a row. However, each nozzle group may include the nozzles 8 which are not arranged in a row.

In the exemplary embodiment, each nozzle group includes the adjacent nozzles 8 communicating with the same row of the pressure chamber rows 11a to 11d. Each nozzle group may include the nozzles 8 which have the ink ejection characteristics similar to each other but are not adjacent to each other.

In the exemplary embodiment, the first to sixteenth line image storage portions 115a to 115p, the first to sixteenth line table storage portions 130a to 130p, and the first to sixteenth line waveform determining portions 131a to 131p are provided on a nozzle group basis. However, an image storage portion, a table storage portion, and a waveform determining portion 131 may be provided on a nozzle basis.

In the exemplary embodiment, the eight waveform patterns W0 to W7 represented by three bits are provided, and the two waveform patterns are provided for each gradation level (not including the waveform pattern W0 for non-ejection waveform pattern W7 for flushing). For example, however, sixteen waveform patterns represented by four bits may be provided, and two each of the waveform patterns are provided for eight gradation levels (not including a waveform patterns for non-ejection and flushing).

In the exemplary embodiment, the functional portions are achieved by hardware components. However, the functional portions may be achieved by software or combinations of hardware and software.

In the exemplary embodiment, the four ink-jet heads 1a to 1d are used. However, the number of ink-jet heads to be used is not limited to the exemplary embodiment. For example, a single ink-jet head or six ink-jet heads may be used. In this case, the correspondence table may be provided for each ink-jet head or a common correspondence table may be provided for the ink-jet heads.

In the exemplary embodiment, the contents of the correspondence tables can be changed by the table update portion 177. However, the contents of the correspondence tables may not be able to be changed.

It is designed such that the optimal corresponding table can be automatically set by the temperature and humidity sensor detecting portion 118 and the sheet detecting portion 119. However, it may be designed such that the corresponding table can be set by at least one of a manufacturer and a user only, without providing the above detecting portions 118, 119.

The ink-jet heads 1a to 1d used in the exemplary embodiment are line heads. However, the head type is not limited to the exemplary embodiment. The ink-jet head may be serial heads.

1. An ink-jet recording apparatus that forms an image based on print data in which a gradation level is selected from a plurality of gradation levels with respect to each pixel, the apparatus comprising:
an ink-jet head, including:
a plurality of nozzles that eject ink therefrom;
a plurality of pressure chambers, each of which communicates with a corresponding nozzle of the plurality of nozzles; and
an actuator that allows the plurality of nozzles to eject ink thereform by applying pressure to ink stored in the plurality of the pressure chambers based on pulse train signals, the actuator being capable of allowing the plurality of nozzles to eject different amounts of ink based on the pulse train signals having different waveform patterns;
a waveform storage unit that stores a plurality of waveform patterns corresponding to the different amounts of ink to be ejected from the nozzles;
table storage units, a table storage unit provided for each nozzle group including at least one of the plurality of nozzles and storing a correspondence table in which one of the plurality of waveform patterns stored in the waveform storage unit is independently selected and brought into correspondence with respect to each of the plurality of a gradation levels; and
a signal generation unit that generates the pulse train signals having the respective waveform patterns, based on the correspondence table stored in each of the table storage unit, so that ink is ejected from each of the nozzles by a volume in accordance with the waveform pattern corresponding to each of the gradation levels.

2. The inkjet recording apparatus according to claim 1, wherein in the correspondence tables stored in the table storage units, a waveform pattern corresponding to a first gradation level for a first nozzle group is the same as a waveform pattern corresponding to a second gradation level for a second nozzle group.

3. The ink-jet recording apparatus according to claim 1, wherein the plurality of nozzles are arranged in a matrix in the ink-jet head, and each of the nozzle groups includes at least one nozzle line including the plurality of nozzles arranged in one direction.

4. The ink-jet recording apparatus according to claim 1, wherein each of the table storage units is provided with respect to each of the nozzles provided in the ink-jet head.

5. The ink-jet recording apparatus according to claim 1, wherein the ink-jet head includes a plurality of ink-jet heads, and each of the table storage units is provided with respect to each nozzle group in each of the plurality of ink-jet heads.

6. The ink-jet recording apparatus according to claim 1, further comprising:
a first detecting unit that detects at least one of ambient temperature and humidity; and
a table update unit that changes the contents of the correspondence tables, stored in the table storage units, based on the detection result by the first detecting unit.

7. The inkjet recording apparatus according to claim 1, further comprising:
a second detecting unit that detects a type of recording media; and
a table update unit that changes the contents of the correspondences table, stored in the table storage units, based on the detection result by the second detecting unit.

8. The ink-jet recording apparatus according to claim 1, further comprising a table update unit that changes the contents of the correspondence tables, stored in the table storage units, based on an operation performed by a user.

9. The ink-jet recording apparatus according to claim 1, wherein the ink-jet head is a line head.

10. A method of forming an image based on print data in which a gradation level is selected from a plurality of gradation levels with respect to each pixel, by using an ink-jet recording apparatus that comprises an ink-jet head including a plurality of nozzles that eject ink therefrom, a plurality of pressure chambers, each pressure chamber communicating with a corresponding one of the plurality of nozzles, and an actuator that allows the plurality of nozzles to eject ink therefrom by applying pressure to ink stored in the plurality of pressure chambers based on pulse train signals and is capable of allowing the plurality of nozzles to eject different amounts of ink based on the pulse train signals having different waveform patterns, comprising:
a correspondence step of bringing different waveform patterns into correspondence with respective gradation levels independently among nozzle groups, each of the nozzle groups including at least one of the nozzles;
a storing step of storing print data in which a gradation level is selected from the gradation levels with respect to each pixel;
a determining step of determining a waveform pattern for ejecting ink from each of the nozzles by a volume corresponding to each gradation level, in accordance with the gradation levels stored in the storing step and the correspondence in the correspondence step;
a generating step of generating a pulse train signal having the waveform pattern determined in the determining step for ejecting ink from each of the nozzles; and
an applying step of applying the pulse train signal generated in the generating step to the actuator.

11. The method according to claim 10, wherein in the corresponding step, a waveform pattern corresponding to a first gradation level for a first nozzle group is the same as a waveform pattern corresponding to a second gradation level for a second nozzle group.

12. The method according to claim 10, further comprising a detecting step of detecting at least one of ambient temperature and humidity, and wherein, in the correspondence step, bringing the different waveform patterns into correspondence with respective gradation levels based on the detection result.

13. The method according to claim 10, further comprising a detecting step of detecting types of recoding media, wherein in the correspondence step, bringing the different waveform patterns into correspondence with respective gradation levels based on the detection result.

14. The method according to claim 10, wherein in the correspondence step, bringing the different waveform patterns into correspondence with respective gradation levels based on an operation performed by a user.

15. An ink-jet printing device, comprising:
at least one ink-jet printhead each such ink-jet printhead having:
a plurality of ink-ejection nozzles;
a plurality of pressure chambers, a pressure chamber associated with each ink ejection nozzle; and
a plurality of actuating elements, an actuating element for each pressure chamber; and
a controller, including:
a central processing unit;
a memory structure; and
a head control portion for each ink-jet printhead of the at least one ink-jet printhead, wherein the head control portion, includes:
a line image storage portion for each printhead nozzle line;
a line table storage portion for each printhead nozzle line;
a waveform determining portion for each nozzle line; and
a signal generator.

16. The ink-jet printing device according to claim 15, further comprising:
an image storing portion that receives image data and provides data to the line image storage portions; and
a waveform storage portion storing a plurality of ink droplet ejection waveforms.

17. The ink-jet printing device according to claim 16, further comprising:
a sensor for sensing at least one of temperature and humidity; and
a sheet sensor for identifying a type sheet for printing.

18. The ink-jet printing device according to claim 17, wherein the waveform storage unit stores at lest two different waveforms for each of a small, medium, and large size ink droplet.

19. The ink-jet printing device according to claim 18, wherein the line table storage portion stores waveform data based upon at least one of user input, temperature data, humidity data or type sheet.
